(19) United States
(12) Patent Application Publication
(10) Pub. No.: US 2026/0291808 A1
(43) Pub. Date: Sep. 24, 2026

(54) INFORMATION PROCESSING METHOD, INFORMATION PROCESSING SYSTEM, ELECTRONIC DEVICE, AND STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Hongda Yu, Beijing (CN); Zhuohua Liu, Beijing (CN); Hongjun Du, Beijing (CN); Huailiang Wang, Beijing (CN); Shiye Li, Beijing (CN); Hao Yuan, Beijing (CN); Guoqi Li, Beijing (CN); Wei Pan, Beijing (CN); Gao Ji, Beijing (CN)

(21) Appl. No.: 19/476,168

(22) PCT Filed: May 14, 2024
(86) PCT No.: PCT/CN2024/093005

§ 371 Date: Oct. 16, 2025

(30) Foreign Application Priority Data
Jun. 20, 2023 (CN) 202310738845.X

(51) Int. Cl. H04L 41/0806; G06F 8/656

(52) U.S. Cl. CPC H04L 41/0806; G06F 8/656

(57) ABSTRACT

The present disclosure provides an information processing method, an information processing system, an electronic device, and a storage medium, which may be applied to fields of communication technology and Internet of Things technology. The information processing method includes: invoking, in response to receiving an information processing request from a source end, an integrated instance corresponding to the information processing request, where the integrated instance supports a corresponding communication protocol, and the integrated instance is deployed on an edge cloud; processing the information processing request by using the integrated instance to obtain processing information, where the processing information includes a target end identifier and orchestration information; and sending the orchestration information to a target end corresponding to the target end identifier by using the integrated instance, such that the target end executes a service operation corresponding to the orchestration information.

### CROSS-REFERENCE TO RELATED APPLICATION(S)

This application is a U.S. National Stage Application of PCT International Application No. PCT/CN 2024/093005, filed on May 14, 2024, which claims priority to the Chinese Patent Application No. 202310738845.X, filed on Jun. 20, 2023, which are incorporated herein by reference in their entireties.

### TECHNICAL FIELD

The present disclosure relates to fields of communication technology and Internet of Things (IOT) technology, in particular to an information processing method, an information processing system, an electronic device, and a storage medium.

### BACKGROUND

With the development of IoT technology, IoT platforms and edge clouds have been widely applied in various fields. For example, service logic orchestration of terminal devices may be performed based on IoT platforms and edge clouds.

### SUMMARY

In view of the above, the present disclosure provides an information processing method, an information processing system, an electronic device, and a storage medium.

According to an aspect of the present disclosure, an information processing method is provided, including: invoking, in response to receiving an information processing request from a source end, an integrated instance corresponding to the information processing request, where the integrated instance supports a corresponding communication protocol, and the integrated instance is deployed on an edge cloud; processing the information processing request by using the integrated instance to obtain processing information, where the processing information includes a target end identifier and orchestration information; and sending the orchestration information to a target end corresponding to the target end identifier by using the integrated instance, such that the target end executes a service operation corresponding to the orchestration information.

According to another aspect of the present disclosure, an information processing system is provided, including: a source end configured to send an information processing request to an edge cloud; the edge cloud configured to: invoke, in response to receiving the information processing request, an integrated instance corresponding to the information processing request, where the integrated instance supports a corresponding communication protocol; process the information processing request by using the integrated instance to obtain processing information, where the processing information includes a target end identifier and orchestration information; and send the orchestration information to a target end corresponding to the target end identifier by using the integrated instance; and the target end configured to execute a service operation corresponding to the orchestration information.

According to another aspect of the present disclosure, an electronic device is provided, including: one or more processors; and a memory for storing one or more instructions, where the one or more instructions, when executed by the one or more processors, are configured to cause the one or more processors to implement the method according to the present disclosure.

According to another aspect of the present disclosure, a computer-readable storage medium having executable instructions therein is provided, where the executable instructions, when executed by a processor, are configured to cause the processor to implement the method according to the present disclosure.

According to another aspect of the present disclosure, a computer program product is provided, where the computer program product includes computer-executable instructions, and the computer-executable instructions, when executed, are configured to implement the method provided by the present disclosure.

### BRIEF DESCRIPTION OF THE DRAWINGS

The above and other objectives, features and advantages of the present disclosure will be more apparent through the following description of embodiments of the present disclosure with reference to the accompanying drawings, wherein:

FIG. 1A schematically shows an example diagram of an architecture of an information processing system according to an embodiment of the present disclosure;

FIG. 1B schematically shows an example diagram of an architecture of an information processing system according to another embodiment of the present disclosure;

FIG. 1C schematically shows an example diagram of an architecture of an information processing system according to another embodiment of the present disclosure;

FIG. 2 schematically shows a flowchart of an information processing method according to an embodiment of the present disclosure;

FIG. 3 schematically shows an example diagram of a process of managing information processing requests by using a message queue according to an embodiment of the present disclosure;

FIG. 4 schematically shows an example diagram of a process of processing an information processing request by using an integrated instance to obtain processing information according to an embodiment of the present disclosure;

FIG. 5 schematically shows an example diagram of a process of generating a first resource download request according to an embodiment of the present disclosure;

FIG. 6 schematically shows an example diagram of an information processing process according to an embodiment of the present disclosure;

FIG. 7 schematically shows a block diagram of an information processing apparatus according to an embodiment of the present disclosure; and

FIG. 8 schematically shows a block diagram of an electronic device suitable for implementing an information processing method according to an embodiment of the present disclosure.

### DETAILED DESCRIPTION OF EMBODIMENTS

Embodiments of the present disclosure will be described below with reference to the accompanying drawings. It should be understood, however, that these descriptions are merely exemplary and are not intended to limit the scope of the present disclosure. In the following detailed descriptions, for purposes of explanation, numerous specific details are set forth in order to provide a thorough understanding of embodiments of the present disclosure. It is obvious, however, that one or more embodiments may be implemented without these specific details. In addition, in the following descriptions, descriptions of well-known structures and technologies are omitted to avoid unnecessarily obscuring the concept of the present disclosure.

Terms used herein are for the purpose of describing embodiments only and are not intended to limit the present disclosure. Terms “comprising”, “including” and the like used herein specify a presence of the feature, step, operation and/or component, but do not preclude a presence or addition of one or more other features, steps, operations or components.

All terms (including technical and scientific terms) used herein have the meaning as commonly understood by those skilled in the art, unless otherwise defined. It should be noted that the terms used herein should be construed to have meanings consistent with the context of the present description and should not be construed in an idealized or overly rigid manner.

Where expressions like “at least one of A, B, and C, etc.” are used, they should generally be interpreted in accordance with the meaning of the expression as commonly understood by those skilled in the art (e.g., “a system having at least one of A, B and C” should include, but not be limited to, a system having A alone, having B alone, having C alone, having A and B, having A and C, having B and C, and/or having A, B, C, etc.).

In the technical solution of the present disclosure, the acquisition, storage, and application of user personal information involved all comply with the provisions of relevant laws and regulations, adopt necessary security measures, and do not violate public order and good customs.

In the technical solution of the present disclosure, prior to acquiring or collecting user personal information, authorization or consent from a user has been obtained.

An IoT platform connects different types of terminal devices, collects data collected by the terminal devices, and processes the data to provide a user with services such as real-time monitoring, early warning, control, and analysis.

An edge cloud provides reliable, efficient, and secure computing resources and storage resources to meet service requirements in edge computing scenarios.

However, since a service logic orchestration method based on the IoT platform and the edge cloud generally needs to obtain a resource based on a cloud service, the number of requests for the cloud service is large, and bandwidth loss is high, which makes it impossible to ensure the efficiency of service logic orchestration.

To this end, embodiments of the present disclosure propose an information processing solution. For example, in response to receiving an information processing request from a source end, an integrated instance corresponding to the information processing request is invoked. The integrated instance supports a corresponding communication protocol, and the integrated instance is deployed on an edge cloud. By using the integrated instance, the information processing request is processed to obtain processing information. The processing information includes a target end identifier and orchestration information. By using the integrated instance, the orchestration information is sent to a target end corresponding to the target end identifier, such that the target end executes a service operation corresponding to the orchestration information.

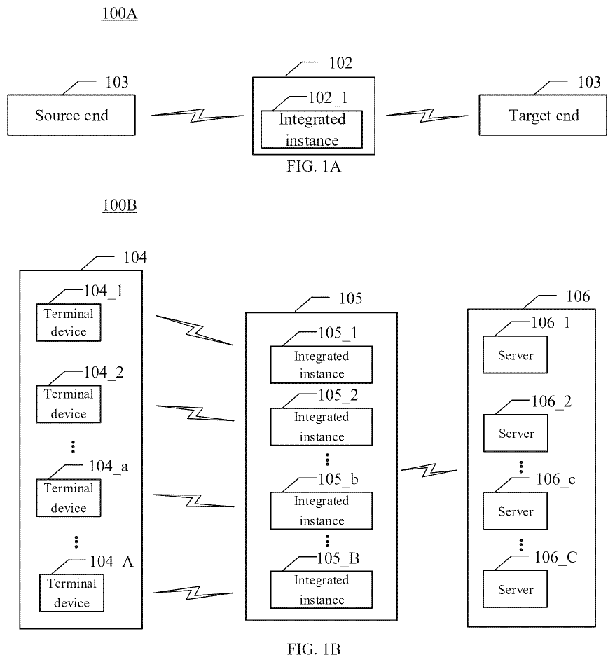

FIG. 1A schematically shows an example diagram of an architecture of an information processing system according to an embodiment of the present disclosure. It should be noted that FIG. 1A is only an example of the architecture of the information processing system to which embodiments of the present disclosure may be applied to help those skilled in the art understand the technical content of the present disclosure, and does not mean that embodiments of the present disclosure may not be applied for other devices, systems, environments, or scenarios.

As shown in FIG. 1A, an information processing system 100A may include a source end 101, an edge cloud 102, and a target end 103.

The source end 101 is configured to send an information processing request to the edge cloud 102.

The edge cloud 102 is configured to: in response to receiving the information processing request, invoke an integrated instance 102_1 corresponding to the information processing request, where the integrated instance 102_1 supports a corresponding communication protocol; process the information processing request by using the integrated instance 102_1 to obtain processing information, where the processing information includes a target end identifier and orchestration information; and send the orchestration information to the target end 103 corresponding to the target end identifier by using the integrated instance 102_1.

The target end 103 is configured to execute a service operation corresponding to the orchestration information.

According to embodiments of the present disclosure, the source end 101 may perform bidirectional communication with the edge cloud 102 through a first communication protocol, and the edge cloud 102 may perform bidirectional communication with the target end 103 through a second communication protocol. The source end 101 and the target end 103 may be decoupled through the edge cloud 102. The first communication protocol of the source end 101 and the second communication protocol of the target end 103 may be the same or different.

FIG. 1B schematically shows an example diagram of an architecture of an information processing system according to another embodiment of the present disclosure.

As shown in FIG. 1B, the information processing system 100B may include a source end 104, an edge cloud 105, and a target end 106. In this case, the source end 104 may be a terminal device, and the target end 106 may be an IoT platform.

The source end 104 may include a terminal device 104_1, a terminal device 104_2, . . . , a terminal device 104_a, . . . , a terminal device 104_A. A may be an integer greater than or equal to 1, and a∈{1, 2, . . . , (A-1), A}.

The edge cloud 105 may be deployed with an integrated instance 105_1, an integrated instance 105_2, . . . , an integrated instance 105_b, . . . , an integrated instance 105_B. B may be an integer greater than or equal to 1, and b € {1, 2, . . . , (B-1), B}.

The target end 103 may include a server 106_1, a server 106_2, . . . , a server 106_c, . . . , a server 106_C. C may be an integer greater than or equal to 1, and c∈{1, 2, . . . , (C-1), C}.

In this case, in response to receiving information processing requests from the terminal device 104_1, the terminal device 104_2, . . . , the terminal device 104_a, . . . , the terminal device 104_A, the edge cloud 105 may invoke the integrated instance 105_1, the integrated instance 105_2, . . . , the integrated instance 105_b, . . . , the integrated instance 105_B corresponding to the information processing requests. The edge cloud 105 may process the information processing requests by using the integrated instance 105_1, the integrated instance 105_2, . . . , the integrated instance 105_b, . . . , the integrated instance 105_B to obtain processing information. The edge cloud 105 may send orchestration information to the server 106_1, the server 106_2, . . . , the server 106_c, . . . , the server 106_C by using the integrated instance 105_1, the integrated instance 105_2, . . . , the integrated instance 105_b, . . . , the integrated instance 105_B.

FIG. 1C schematically shows an example diagram of an architecture of an information processing system according to another embodiment of the present disclosure.

As shown in FIG. 1C, an information processing system 100C may include a source end 107, an edge cloud 108, and a target end 109. In this case, the source end 107 may be an IoT platform, and the target end 109 may be a terminal device.

The source end 107 may include a server 107_1, a server 107_2, . . . , a server 107_c, . . . , a server 107_C. C may be an integer greater than or equal to 1, and c∈{1, 2, . . . , (C-1), C}.

The edge cloud 108 may be deployed with an integrated instance 108_1, an integrated instance 108_2, . . . , an integrated instance 108_n, . . . , an integrated instance 108_N. N may be an integer greater than or equal to 1, and n∈{1, 2, . . . , (N-1), N}.

The target end 109 may include a terminal device 109_1, a terminal device 109_2, . . . , a terminal device 109_m, . . . , a terminal device 109_M. M may be an integer greater than or equal to 1, and m∈{1, 2, . . . , (M-1), M}.

In this case, in response to receiving information processing requests from the server 107_1, the server 107_2, . . . , the server 107_c, . . . , the server 107_C, the edge cloud 108 may invoke the integrated instance 108_1, the integrated instance 108_2, . . . , the integrated instance 108_n, . . . , the integrated instance 108_N corresponding to the information processing requests. The edge cloud 108 may process the information processing requests by using the integrated instance 108_1, the integrated instance 108_2, . . . , the integrated instance 108_n, . . . , the integrated instance 108_N to obtain processing information. The edge cloud 108 may send orchestration information to the terminal device 109_1, the terminal device 109_2, . . . , the terminal device 109_m, . . . , the terminal device 109_M by using the integrated instance 108_1, the integrated instance 108_2, . . . , the integrated instance 108_n, . . . , the integrated instance 108_N. It should be noted that the information processing method provided by embodiments of the present disclosure may generally be executed by the edge cloud 102, the edge cloud 105, and/or the edge cloud 108. Correspondingly, the information processing apparatus provided by embodiments of the present disclosure may generally be disposed in the edge cloud 102, the edge cloud 105, and/or the edge cloud 108. The information processing method provided by embodiments of the present disclosure may also be executed by a server or a cluster of servers that is different from the edge cloud 102, the edge cloud 105, and/or the edge cloud 108 and may communicate with the source end 101, the source end 104, and/or the source end 107; the edge cloud 102, the edge cloud 105, and/or the edge cloud 108; and the target end 103, the target end 106, and/or the target end 109. Correspondingly, the information processing apparatus provided by embodiments of the present disclosure may also be disposed in a server or a cluster of servers that is different from the edge cloud 102, the edge cloud 105, and/or the edge cloud 108 and may communicate with the source end 101, the source end 104, and/or the source end 107; the edge cloud 102, the edge cloud 105, and/or the edge cloud 108; and the target end 103, the target end 106, and/or the target end 109.

Alternatively, the information processing method provided by embodiments of the present disclosure may also be executed by the source end 101, the source end 104, and/or the source end 107, or the target end 103, the target end 106, and/or the target end 109, or by other terminal devices different from the source end 101, the source end 104, and/or the source end 107, or the target end 103, the target end 106, and/or the target end 109. Correspondingly, the information processing apparatus provided by embodiments of the present disclosure may also be disposed in the source end 101, the source end 104, and/or the source end 107, or the target end 103, the target end 106, and/or the target end 109, or in a device different from the source end 101, the source end 104, and/or the source end 107, or the target end 103, the target end 106, and/or the target end 109.

It should be understood that the number of source ends, edge clouds, target ends, terminal devices, servers, and integrated instances in FIG. 1 is merely illustrative. There may be any number of source ends, edge clouds, target ends, terminal devices, servers, and integrated instances as desired for implementation.

It should be noted that the sequence numbers of the respective operations in the following methods are only used as a representation of the operations for description, and should not be regarded as representing the execution order of the respective operations. The method does not need to be performed in the exact order shown, unless explicitly stated.

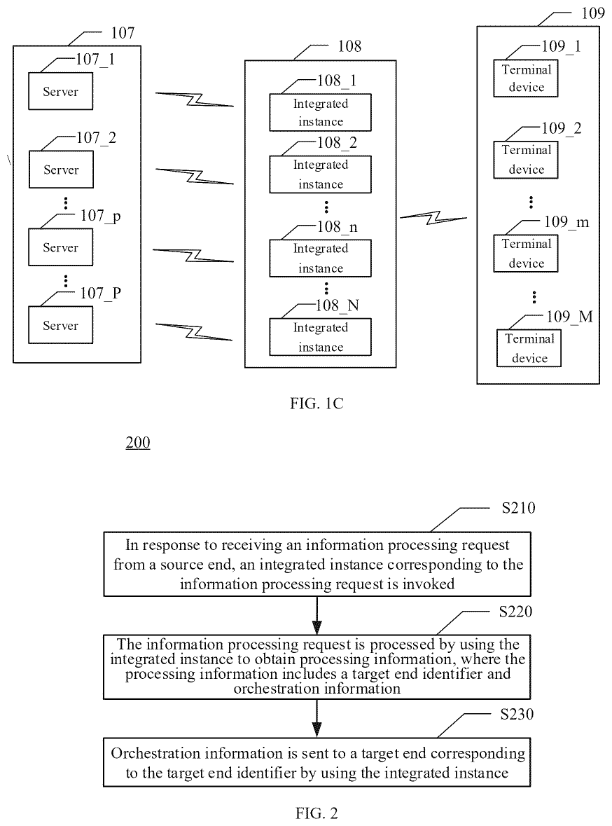

FIG. 2 schematically shows a flowchart of an information processing method according to an embodiment of the present disclosure.

As shown in FIG. 2, a method 200 includes operation S210 to operation S230.

In operation S210, in response to receiving an information processing request from a source end, an integrated instance corresponding to the information processing request is invoked.

In operation S220, the information processing request is processed by using the integrated instance to obtain processing information.

In operation S230, orchestration information is sent to a target end corresponding to the target end identifier by using the integrated instance, such that the target end executes a service operation corresponding to the orchestration information.

According to embodiments of the present disclosure, the integrated instance may support a corresponding communication protocol. The integrated instance may be deployed on an edge cloud. The processing information may include a target end identifier and orchestration information.

According to embodiments of the present disclosure, the information processing method provided by the present disclosure may be applied to an edge cloud. The edge cloud may run on an edge server. The edge cloud may refer to a cloud computing platform deployed on edge infrastructure based on the core of cloud computing and edge computing capabilities. The edge cloud may serve as a medium for interaction between the source end and the target end. For example, the edge cloud may process device connections of the source end, thereby maintaining a bidirectional communication channel with the source end. Alternatively, the edge cloud may process device connections of the target end, thereby maintaining a bidirectional communication channel with the target end.

According to embodiments of the present disclosure, different types of terminal devices may communicate with an Internet of Things (IOT) platform by accessing the integrated instances. A terminal device may refer to a demand end of a cloud computing service, such as a terminal or a user end in the Internet. The types of terminal devices may include at least one of: a sensor, a smart home device, an industrial device, a medical device, and an Internet of Vehicles device.

According to embodiments of the present disclosure, a plurality of integrated instances may be pre-created and deployed on the edge cloud. For example, an integrated instance may be pre-created according to instance configuration information. By using the integrated instance, an information processing request from a source end may be processed to obtain processing information.

According to embodiments of the present disclosure, a communication protocol may be used to specify a communication mode between the integrated instance and the source end. By adopting different information processing methods for different communication protocols, communication between different types of terminal devices and the IoT platform may be supported. The communication protocol may include at least one of: Transmission Control Protocol (TCP), User Datagram Protocol (UDP), Message Queuing Telemetry Transport (MQTT), Hyper Text Transfer Protocol (HTTP), Constrained Application Protocol (CoAP), or other customized protocols.

According to embodiments of the present disclosure, the integrated instance may support a corresponding communication protocol. The integrated instances may include at least one of: an integrated instance for managing terminal devices accessing via the TCP protocol, an integrated instance for managing devices accessing via the UDP protocol, an integrated instance for managing devices accessing via the MQTT protocol, an integrated instance for managing devices accessing via the HTTP protocol, or an integrated instance for managing devices accessing via the CoAP protocol.

According to embodiments of the present disclosure, since different types of terminal devices may be suitable for data in different formats, format conversion of the data from the terminal device may be performed according to a data protocol corresponding to the type of the terminal device, so as to unify the data formats. The data protocol may be used to specify a data exchange format between the integrated instance and the terminal device. The data format may include at least one of: JavaScript Object Notation (JSON) format, Test Expression (test) format, Binary format, or the like.

According to embodiments of the present disclosure, the information processing request may be used to request execution of an information processing operation. The information processing request may include at least one of: to-be-processed information, an identifier of to-be-processed information, an identifier of the information processing request, a script identifier corresponding to the information processing request, or metadata for running a script corresponding to the information processing request.

According to embodiments of the present disclosure, a first script for generating an information processing request may be pre-stored in the source end. In response to detecting an information processing operation initiated by a user, to-be-processed information corresponding to the information processing operation may be acquired. An information processing request is generated according to the to-be-processed information by using the first script. After obtaining the information processing request, the source end may send the information processing request to the edge cloud. After receiving the information processing request, the edge cloud may invoke an integrated instance corresponding to the information processing request according to the information processing request.

For example, in a case that the source end is a terminal device, the target end is an IoT platform, the information processing request is an information acquisition request, the to-be-processed information may include information uploaded by the terminal device to the IoT platform, and an integrated instance corresponding to the information acquisition request may be invoked. In this case, the integrated instance corresponding to the information acquisition request may be used to process information from the terminal device according to the requirements of the IoT platform.

Alternatively, in a case that the source end is an IoT platform, the target end is a terminal device, the information processing request is an Over-The-Air Upgrade (OTA) request, the to-be-processed information may include information issued by the IoT platform to the terminal device, and an integrated instance corresponding to the OTA request may be invoked. In this case, the integrated instance corresponding to the OTA request may be used to process information from the IoT platform according to the requirements of the terminal device.

According to embodiments of the present disclosure, after obtaining the integrated instance, the information processing request may be processed by using the integrated instance to obtain processing information. The integrated instance may include at least one candidate routine (i.e., Example). The candidate routine may refer to an example program or sample code for implementing a specific function. The functions that may be implemented by the candidate routine may include at least one of: a learning reference function, a prototype development function, a function reuse function, a troubleshooting function, a parsing function, or a logic orchestration function.

For example, in a case that the troubleshooting function needs to be implemented, the candidate routine may include a troubleshooting routine. In this case, the troubleshooting routine may be used to troubleshoot the information processing request to obtain processing information. Alternatively, in a case that the parsing function needs to be implemented, the candidate routine may include a parsing routine. In this case, the parsing routine may be used to parse the information processing request to obtain processing information. Alternatively, in a case that the logic orchestration function needs to be implemented, the candidate routine may include a logic orchestration routine. In this case, the logic orchestration routine may be used to perform logic orchestration on the information processing request to obtain processing information.

According to embodiments of the present disclosure, specific processing methods may include at least one of: communication protocol conversion or data format conversion. For example, in a case that the data format of the source end is consistent with the data format of the target end, communication protocol conversion may be performed by using the integrated instance so as to obtain processing information. Alternatively, in a case that the data format of the source end is inconsistent with the data format of the target end and the communication protocol of the source end is consistent with the communication protocol of the target end, data format conversion may be performed by using the integrated instance so as to obtain processing information. Alternatively, in a case that both the data format and communication protocol of the source end are inconsistent with those of the target end, both communication protocol conversion and data format conversion may be performed by using the integrated instance so as to obtain processing information.

According to embodiments of the present disclosure, the processing information may include a target end identifier and orchestration information. The target end identifier may be used to represent different target terminals. The target terminals may be maintained through an IoT platform. The IoT platform may refer to a cloud service platform which is designed based on cloud computing technology and supports IoT applications. The IoT platform may provide various communication protocols, various data formats, various types of device connections, data collection, device management, data analysis, device shadow, and application development.

According to embodiments of the present disclosure, the orchestration information may be obtained by performing logic orchestration on the information processing request. The logic orchestration may refer to a process of organizing execution actions of the target end through a protocol script function. The orchestration information is used to control the target end to execute a service operation corresponding to the orchestration information. After obtaining the target end identifier and the orchestration information, the orchestration information may be sent to the target end corresponding to the target end identifier by using the integrated instance, such that the target end executes the service operation corresponding to the orchestration information.

According to embodiments of the present disclosure, since the integrated instance is invoked by the edge cloud in response to receiving an information processing request from the source end, the integrated instance may correspond to the information processing request. On this basis, the information processing request are processed by using the integrated instance deployed on the edge cloud, so as to obtain the target end identifier and orchestration information, and the orchestration information is sent to the target end corresponding to the target end identifier by using the integrated instance. In this way, data forwarding between the source end and the target end may be realized, so as to reduce the number of requests for cloud services and bandwidth requirements, and improve the efficiency of information processing. By using the integrated instance to send the orchestration information to the target end corresponding to the target end identifier, the target end may automatically execute the service operation corresponding to the orchestration information, which improves the efficiency of service logic orchestration and further enhances the communication efficiency between the source end and the target end.

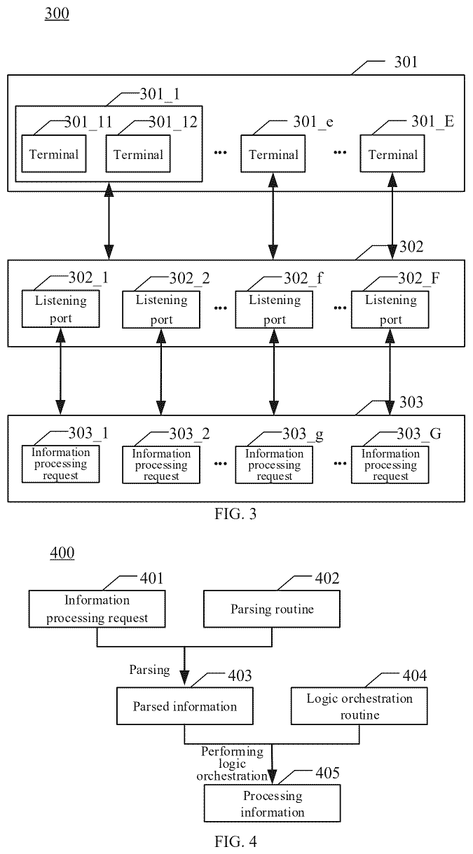

The information processing method 200 according to embodiments of the present invention is further described below with reference to FIG. 3 to FIG. 6.

According to embodiments of the present disclosure, the information processing method 200 may further include the following operations.

In response to detecting a creation instruction for an integrated instance, instance configuration information corresponding to the creation instruction is acquired. The integrated instance is created according to the instance configuration information.

According to embodiments of the present disclosure, a second script for generating a creation instruction may be pre-stored in the source end. In response to detecting a creation operation of a user for an integrated instance, instance configuration information corresponding to the integrated instance may be acquired. A creation instruction corresponding to the integrated instance is generated according to the instance configuration information by using the second script. After obtaining the creation instruction, the source end may send the creation instruction to the edge cloud. After receiving the creation instruction, the edge cloud may acquire the instance configuration information according to the creation instruction to create the integrated instance.

According to embodiments of the present disclosure, a creation operation for an integrated instance may refer to an instance creation operation performed by a developer. For example, a developer may configure parameter setting of the instance on a compilation interface, click instance creation, and determine setting parameters of the instance as the instance configuration information. On this basis, an integrated instance may be generated based on the instance configuration information compiled by the developer, and after generating the integrated instance, the integrated instance may be executed in response to a running operation performed by the developer.

According to embodiments of the present disclosure, before creating an integrated instance, a developer may pre-compile a data conversion script corresponding to each communication protocol. For example, a data conversion script may be obtained by performing targeted compilation according to the data format of the data sent by the terminal corresponding to the communication protocol. The data conversion script may include an uplink data conversion script and a downlink data conversion script. The uplink data conversion script may be used to convert the information processing request sent by the source end to the target end into a data format required by the target end. The downlink data conversion script is used to convert the information processing request sent by the target end to the source end into a data format required by the source end.

According to embodiments of the present disclosure, the instance configuration information may include setting parameters of the instance. The setting parameters of the instance may include configuration parameters related to the operation of the integrated instance, such as a instance name of the integrated instance, a type of communication protocol, an indication of whether the instance is to be enabled, an uplink data conversion script, a downlink data conversion script, a port address, a maximum request length of a connection queue, a size of a data receiving buffer, a size of a data sending buffer, a instance description, a metadata of the integrated instance, and auxiliary information.

According to embodiments of the present disclosure, different communication protocols may correspond to different integrated instances. For example, the TCP protocol may correspond to an integrated instance for managing a terminal device accessing via the TCP protocol, the UDP protocol may correspond to an integrated instance for managing a terminal device accessing via the UDP protocol, and the MQTT protocol may correspond to an integrated instance for managing a terminal device accessing via the MQTT protocol. The integrated instance may be used to provide a communication service for a terminal using the communication protocol.

According to embodiments of the present disclosure, operation S210 may include the following operations.

In response to detecting the information processing request from the source end at a listening port, an integrated instance corresponding to the listening port is determined from a plurality of integrated instances. The integrated instance corresponding to the listening port is invoked.

According to embodiments of the present disclosure, after the plurality of integrated instances deployed on the edge cloud are started, for integrated instances corresponding to different communication protocols, listening ports corresponding to the communication protocols may be created, and the listening ports are used to monitor the information processing request. For example, for the TCP protocol, a listening port (i.e., a TCP server) corresponding to the TCP protocol may be created. Alternatively, for HTTP protocol, a listening port (i.e., a HTTP server) corresponding to the HTTP protocol may be created.

According to embodiments of the present disclosure, a port pool may refer to a set of available ports. The port pool may maintain a plurality of ports for listening and binding of integrated instances. For each integrated instance, when the integrated instance is started, a target port corresponding to the integrated instance may be determined from the plurality of ports included in the port pool. The manner of determining the target port may be configured according to actual service requirements, which is not limited herein. For example, the target port corresponding to the integrated instance may be determined in sequence according to a sequential port number. Alternatively, the target port corresponding to the integrated instance may be determined according to a predetermined condition.

According to embodiments of the present disclosure, the plurality of ports may include a reserved port, a used port, and an idle port. The reserved port may refer to a port that is reserved but not used among the plurality of ports. The used port may refer to a port that is reserved and used among the plurality of ports. The idle port may refer to a port that is not used and not reserved among the plurality of ports.

According to embodiments of the present disclosure, the predetermined condition may be configured according to actual service requirements, which is not limited herein. For example, the predetermined condition may be configured to preferentially select an idle port, i.e., a port that is not used and not reserved, among the plurality of ports as the target port corresponding to the integrated instance. Alternatively, in a case that there is no idle port among the plurality of ports, a reserved port, i.e., a port that is reserved but not used, among the plurality of ports may be preferentially selected as the target port corresponding to the integrated instance. Alternatively, in a case that there is no idle port or reserved port among the plurality of ports, it may be determined that the listening port allocation fails.

According to embodiments of the present disclosure, by enabling a multithreading mode, a plurality of integrated instances may be monitored in parallel by using different listening ports, such that the operation may be performed in a concurrent mode, and the transmit-receive throughput of the listening ports is improved.

According to embodiments of the present disclosure, operation S210 may further include the following operations.

The information processing request monitored by the listening port is stored in a message queue, so as to acquire the information processing request from the message queue.

According to embodiments of the present disclosure, a message queue may refer to a communication mechanism for delivering messages between a sender and a receiver. The message queue may store and forward messages through a message server, such that the sending and receiving of messages may be performed asynchronously without an immediate response.

According to embodiments of the present disclosure, the edge cloud may maintain a plurality of message queues. The specific number and specific uses of the plurality of message queues may be configured according to actual service requirements, which is not limited herein. For example, the plurality of message queues may include a first message queue and a second message queue. The first message queue may be used to manage information processing requests from the terminal to the IoT platform. The second message queue may be used to manage information processing requests from the IoT platform to the terminal.

According to embodiments of the present disclosure, for example, after the listening port monitors an information processing request from the terminal to the IoT platform, the information processing request may be added to the first message queue. In this case, the edge cloud may forward the information processing request stored in the first message queue to the IoT platform. Alternatively, after an information processing request from the IoT platform to the terminal is detected at the listening port, the information processing request may be added to the second message queue. In this case, the edge cloud may forward the information processing request stored in the second message queue to the terminal.

According to embodiments of the present disclosure, the first message queue and the second message queue may implement forwarding of information processing requests through subscription. For example, the IoT platform may send a first identifier of the first message queue to the edge cloud to subscribe to the first message queue from the edge cloud. After an information processing request from the terminal to the IoT platform is detected at the listening port, the information processing request may be added to the first message queue, and the information processing request in the first message queue may be sent to the IoT platform.

Alternatively, the terminal may send a second identifier of the second message queue to the edge cloud to subscribe to the second message queue from the edge cloud. After an information processing request from the IoT platform to the terminal is detected at the listening port, the information processing request may be added to the second message queue, and the information processing request in the second message queue may be sent to the terminal.

According to embodiments of the present disclosure, information processing requests detected at a plurality of listening ports may be concurrently delivered to the message queue by using a plurality of first working threads, and the message queue may store the plurality of information processing requests. On this basis, the plurality of information processing requests may be concurrently retrieved by using a plurality of second working threads, in order for subsequent processing. The plurality of first working threads and the plurality of second working threads may work independently of each other to ensure concurrent security.

According to embodiments of the present disclosure, since the source end and the target end may be independently deployed, expanded, and maintained, the flexibility and maintainability of the information processing system may be improved. On this basis, by using the message queue to cache and manage the information processing requests detected at the listening port, the ordering of the information processing requests may be ensured. In addition, since the information processing requests cached in the message queue will not be deleted until the message queue is full, the persistence of the information processing requests may be guaranteed.

According to embodiments of the present disclosure, operation S210 may further include the following operations.

The listening ports respectively corresponding to the plurality of integrated instances are monitored to obtain second monitoring information respectively corresponding to the plurality of integrated instances. In a case that a faulty integrated instance is detected according to the second monitoring information respectively corresponding to the plurality of integrated instances, the faulty integrated instance is repaired.

According to embodiments of the present disclosure, the second monitoring information may be used to represent the operating state of the integrated instance. The listening ports respectively corresponding to the plurality of integrated instances may be monitored to obtain second monitoring information respectively corresponding to the plurality of integrated instances. On this basis, the faulty integrated instance may be identified according to the second monitoring information respectively corresponding to the plurality of integrated instances. The faulty integrated instance may be repaired. Repair may include at least one of: stopping, restarting, or replacing.

According to embodiments of the present disclosure, the specific manner of monitoring the integrated instance may be configured according to actual service requirements, which is not limited herein. For example, the integrated instance may be monitored by sending heartbeat packets to the plurality of integrated instances respectively and receiving data packets returned by the plurality of integrated instances. The operating states of the plurality of integrated instances may be determined according to the data packets returned by the plurality of integrated instances, and the integrated instance whose operating state indicates a fault may be restarted. Alternatively, a monitoring program may be developed, and the monitoring program may be used to monitor the operating state of each of the plurality of integrated instances and whether each of the plurality of integrated instances is online or not, and restart the integrated instance that is offline and whose operating state indicates a fault.

According to embodiments of the present disclosure, the operating state may include at least one of: an operating state or a service state. The operating state may refer to the operating status of the process of the integrated instance, i.e., whether the process is operating normally. The service state may refer to whether the forwarding of interactive data packets between the IoT platform and the terminal is normal when the integrated instance provides the information processing service.

According to embodiments of the present disclosure, monitoring the integrated instance may include monitoring the operating state of the integrated instance. Alternatively, monitoring the integrated instance may include monitoring the service state of the integrated instance. Alternatively, monitoring the integrated instance may include monitoring both the operating state and the service state of the integrated instance.

According to embodiments of the present disclosure, the second monitoring information may include at least one of: a heartbeat data packet and an operating log during operation. For example, in a case that the second monitoring information includes a heartbeat data packet, the instance object corresponding to the integrated instance may be used to periodically capture the heartbeat data packet of the listening port during operation, and determine the operating state of the integrated instance according to the captured heartbeat data packet.

According to embodiments of the present disclosure, alternatively, if the second monitoring information includes an operating log during operation, the instance object corresponding to the integrated instance may be used to acquire the operating log of the integrated instance during operation by monitoring a specified channel, and determine the operating state and the service state of the integrated instance according to the acquired operating log during operation.

According to embodiments of the present disclosure, it may be determined whether the operating state of the integrated instance has a fault by detecting whether the process is alive and whether the service is available. It may be determined whether the service state of the integrated instance has a fault by detecting whether a fault code appears in the operating log. In a case of a faulty integrated instance is identified, the instance object may feed back the operating state of the faulty integrated instance to an access component, so as to determine the specific manner of repairing the faulty integrated instance according to the information fed back by the access component for the fault state.

According to embodiments of the present disclosure, in a case of a faulty integrated instance is identified according to the second monitoring information respectively corresponding to the plurality of integrated instances, the following operations may be included.

A target integrated instance corresponding to the faulty integrated instance is determined from at least one alternative integrated instance, so as to replace the faulty integrated instance with the target integrated instance.

According to embodiments of the present disclosure, in a case that a faulty integrated instance is identified according to the second monitoring information respectively corresponding to the plurality of integrated instances and the faulty integrated instance needs to be repaired, the operation of the original integrated instance may be stopped. Since integrated instances for different communication protocols may correspond to different objects in the memory, the operation of the original integrated instance may be stopped through the corresponding object in the memory if the operation of the original integrated instance needs to be stopped.

According to embodiments of the present disclosure, for the same communication protocol, a plurality of alternative integrated instances may be available for invocation. Different alternative integrated instances may be deployed in different operating environments. The plurality of alternative integrated instances may respond to the connection of the terminal through a unified external interface. In a case that a terminal is accessed, the terminal may be scheduled to any one of the plurality of alternative integrated instances, such that a communication service is provided for the terminal by the scheduled alternative integrated instance.

According to embodiments of the present disclosure, the specific manner of determining the target integrated instance corresponding to the faulty integrated instance from at least one alternative integrated instance may be configured according to actual service requirements, which is not limited herein. For example, the manner of determining the target integrated instance may include at least one of: determining the target integrated instance based on operating environment parameters, or determining the target integrated instance based on terminal access frequency.

According to embodiments of the present disclosure, a to-be-scheduled alternative integrated instance may be determined according to parameters of operating environment in which each of the plurality of alternative integrated instances operates. The parameters of operating environment may be used to represent the current hardware and software performance of the operating environment in which the alternative integrated instance operates, such as a remaining computing resource of a hardware, a software version, and an operating rate. In this case, the alternative integrated instance running in an operating environment with better performance may be determined according to the parameters of operating environment, and this alternative integrated instance may be determined as the target integrated instance for replacing the faulty integrated instance and providing communication services for the terminal, so as to schedule the terminal to the target integrated instance.

According to embodiments of the present disclosure, different alternative integrated instances may provide different ports to the outside for the terminal to access. Accordingly, when the terminal is scheduled to the target integrated instance, the terminal may be connected to the port provided to the outside by the target integrated instance, such that the terminal may communicate with the IoT platform through the port subsequently.

According to embodiments of the present disclosure, a to-be-scheduled alternative integrated instance may be determined according to the access frequency of the terminal. The access frequency may be used to represent the frequency of the terminal accessing the IoT platform. The access frequency may be determined according to the frequency of the terminal accessing the IoT platform within a preset period before the current time.

According to embodiments of the present disclosure, if the access frequency is high, the terminal is scheduled to an alternative integrated instance with a high performance configuration of the operating environment. For example, if the access frequency exceeds a first predetermined threshold, the terminal may be scheduled to an alternative integrated instance whose operating environment has a performance configuration exceeding a preset performance configuration.

According to embodiments of the present disclosure, if the access frequency is high, the terminal is scheduled to an alternative integrated instance with less connected external terminals. For example, if the access frequency exceeds a second predetermined threshold, the terminal may be scheduled to an alternative integrated instance with the number of accessed terminals less than a preset number.

According to embodiments of the present disclosure, a to-be-scheduled alternative integrated instance may be determined based on both the access frequency of the terminal and the operating environment parameters. For example, it is possible to predetermine different levels of access frequency, including a high-level frequency, a medium-level frequency, and a low-level frequency, where the lower level indicates a lower access frequency, so as to determine the target integrated instance from at least one alternative integrated instance according to the level of access frequency. Alternatively, it is possible to predetermine different levels of operating environment parameters including high-level environment parameters, medium-level environment parameters, and low-level environment parameters, where a lower level indicates lower performance of the current operating environment, so as to determine the level of each of the at least one alternative integrated instance according to the operating environment parameters of each of the at least one alternative integrated instance.

According to embodiments of the present disclosure, since the second monitoring information is obtained by monitoring the listening ports respectively corresponding to the plurality of integrated instances, the faulty integrated instance may be timely identified by the continuous health monitoring of the listening ports respectively corresponding to the plurality of integrated instances. On this basis, in a case of determining that a faulty integrated instance is identified according to the second monitoring information respectively corresponding to the plurality of integrated instances, the faulty integrated instance may be repaired, so as to automatically eliminate the faulty integrated instance and restart a new integrated instance, thereby ensuring high availability of the integrated instance.

FIG. 3 schematically shows an example diagram of a process of managing information processing requests by using a message queue according to an embodiment of the present disclosure.

As shown in FIG. 3, in 300, a source end 301 may be deployed with a gateway 301_1, . . . , a terminal 301_e, . . . , a terminal 301_E. The gateway 301_1 may include a terminal 301_11 and a terminal 301_12. E may be an integer greater than or equal to 1, and e∈{1, 2, . . . ,(E-1), E}.

A TCP Server 302 may be provided with a listening port 302_1, a listening port 302_2, . . . , a listening port 302_f, . . . , a listening port 302_F. F may be an integer greater than or equal to 1, and f∈{1, 2, . . . , (F-1), F}.

A message queue 303 may store an information processing request 303_1, an information processing request 303_2, . . . , an information processing request 303_g, . . . , an information processing request 303_G. G may be an integer greater than or equal to 1, and g∈{1,2, . . . , (G-1), G}.

The listening port 302_1, the listening port 302_2, . . . , the listening port 302_f, . . . , the listening port 302_F in the TCP Server 302 may be used to monitor the gateway 301_1, . . . , the terminal 301_e, . . . , the terminal 301_E. In response to the listening port 302_1, the listening port 302_2, . . . , the listening port 302_f, . . . , the listening port 302_F detect an information processing request from the source end, the information processing request 303_2, . . . , the information processing request 303_g, . . . , the information processing request 303_G may be stored in the message queue 303.

According to embodiments of the present disclosure, operation S220 may include the following operations.

The information processing request is parsed by using a parsing routine to obtain parsed information. Logic orchestration is performed on the parsed information by using a logic orchestration routine to obtain processing information.

According to embodiments of the present disclosure, the integrated instance may include a parsing routine and a logic orchestration routine.

According to embodiments of the present disclosure, the parsing routine may refer to an example program or a sample code for implementing a parsing function. The parsing routine may be used to parse the information processing request to obtain parsed information. The logic orchestration routine may refer to an example program or a sample code for implementing a logic orchestration function. The logic orchestration routine may be used to perform logic orchestration on the parsed information to obtain processing information.

FIG. 4 schematically shows an example diagram of a process of processing an information processing request by using an integrated instance to obtain processing information according to an embodiment of the present disclosure.

As shown in FIG. 4, in 400, after receiving an information processing request 401, a parsing routine 402 may be used to parse the information processing request 401 to obtain parsed information 403. A logic orchestration routine 404 may be used to perform logic orchestration on the parsed information 403 to obtain processing information 405.

According to embodiments of the present disclosure, the information processing method 200 may further include the following operations.

By using the integrated instance, a first resource download request is generated according to the first resource identifier, in response to determining that a first resource corresponding to a first resource identifier does not exist in a resource set, generate. By using the integrated instance, the first resource download request is sent to the IoT platform, such that the IoT platform acquires the first resource corresponding to the first resource identifier. By using the integrated instance, the first resource is sent to the terminal device in response to receiving the first resource from the IoT platform.

According to embodiments of the present disclosure, the source end may be a terminal device. The information processing request may be an information acquisition request. The parsed information may include a first resource identifier.

According to embodiments of the present disclosure, the resource set may include at least one candidate first resource identifier. Each of the at least one candidate first resource identifier may correspond to a first resource. In a case that the source end is a terminal device and the target end is an IoT platform, the the information acquisition request may be parsed by using a parsing routine, so as to obtain a first resource identifier.

According to embodiments of the present disclosure, after obtaining the first resource identifier, the first resource identifier may be matched with each of the at least one candidate first resource identifier to obtain a first matching result corresponding to each of the at least one candidate first resource identifier. In response to at least one first matching result indicating that none of the at least one candidate first resource identifier matches the first resource identifier, i.e., determining that the first resource corresponding to the first resource identifier does not exist in the resource set, a first resource download request may be generated according to the first resource identifier.

According to embodiments of the present disclosure, after obtaining the first resource download request, the first resource download request may be sent to the IoT platform by using the integrated instance. After receiving the first resource download request, the IoT platform may determine the first resource identifier in the first resource download request. The IoT platform may acquire the first resource corresponding to the first resource identifier according to the first resource identifier.

According to embodiments of the present disclosure, after obtaining the first resource corresponding to the first resource identifier, the IoT platform may send the first resource to the edge cloud. By using the integrated instance, the edge cloud may send the first resource to the terminal device in response to receiving the first resource from the IoT platform.

According to embodiments of the present disclosure, the information processing method 200 may further include the following operations.

The first resource and the first resource identifier are stored in association in the resource set by using the integrated instance.

According to embodiments of the present disclosure, by using the integrated instance, the edge cloud may further store the first resource identifier and the first resource in association in the resource set in response to receiving the first resource from the IoT platform, such that the terminal may subsequently acquire the first resource of the IoT platform via the edge cloud.

According to embodiments of the present disclosure, the first resource identifier may include a Message-Digest Algorithm 5 (MD5) value. The resource set deployed on the edge cloud may be used to manage files required by the integrated instance. For example, the file may include an OTA upgrade package and a configuration file. The same file occupies a single storage space in the resource set.

According to embodiments of the present disclosure, the generating, in response to determining that a first resource corresponding to the first resource identifier does not exist in a resource set, a first resource download request according to the first resource identifier by using the integrated instance may include the following operations.

In response to determining that first resources corresponding to first resource identifiers respectively corresponding to the plurality of information acquisition requests do not exist in the resource set, and that the plurality of first resource identifiers are consistent, the first resource download request is generated according to the first resource identifier by using the integrated instance.

According to embodiments of the present disclosure, there may be a plurality of information acquisition requests and at least one terminal device.

According to embodiments of the present disclosure, in a case that the source end is a terminal device and the target end is an IoT platform, the plurality of information acquisition requests may be parsed respectively by using a parsing routine, so as to obtain first resource identifiers respectively corresponding to the plurality of information acquisition requests.

According to embodiments of the present disclosure, after obtaining the first resource identifiers respectively corresponding to the plurality of information acquisition requests, the first resource identifiers respectively corresponding to the plurality of information acquisition requests may be matched with at least one candidate first resource identifier in the resource set respectively to obtain a second matching result. If the second matching result indicates that none of the first resources corresponding to the first resource identifiers corresponding to the plurality of information acquisition requests respectively exists in the resource set and the plurality of first resource identifiers are consistent, requests for the same first resource may be merged into one request, i.e., a first resource download request is generated according to the first resource identifier.

According to embodiments of the present disclosure, after obtaining the first resource download request, the first resource download request may be sent to the IoT platform by using the integrated instance. After receiving the first resource download request, the IoT platform may determine the first resource identifier in the first resource download request. The IoT platform may acquire the first resource corresponding to the first resource identifier according to the first resource identifier, i.e., only one public network download is performed.

According to embodiments of the present disclosure, after obtaining the first resource corresponding to the first resource identifier, the IoT platform may send the first resource to the edge cloud. In response to receiving the first resource from the IoT platform, the edge cloud may send the first resource to each of the at least one terminal device by using the integrated instance.

According to embodiments of the present disclosure, in a case of determining that none of the first resources corresponding to first resource identifiers respectively corresponding to the plurality of information acquisition requests exists in the resource set and that the plurality of first resource identifiers are consistent, requests for the same first resource may be merged into one request, i.e., a first resource download request is generated according to the first resource identifier. Therefore, the first resource corresponding to the first resource identifier may be acquired by performing one public network download using the first resource download request, which avoids the high pressure of the server due to a plurality of concurrent requests, reduces the number of requests for cloud services and the bandwidth requirements, and helps improve the efficiency of subsequent service logic orchestration.

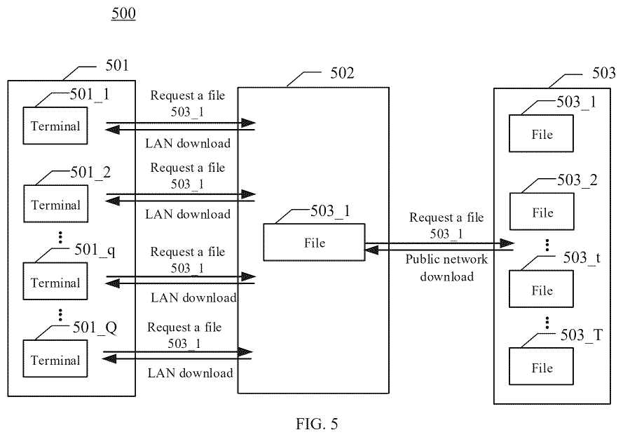

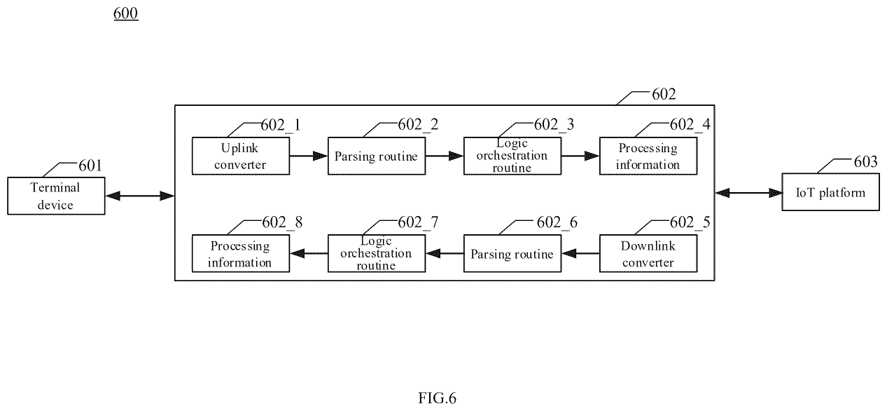

FIG. 5 schematically shows an example diagram of a process of generating a first resource download request according to an embodiment of the present disclosure.

As shown in FIG. 5, in 500, a source end 501 may include a terminal 501_1, a terminal 501_2, . . . , a terminal 501_q, . . . , a terminal 501_Q. The terminal 501_1, terminal 501_2, . . . , terminal 501_q, . . . , terminal 501_Q may send an information acquisition request to the edge cloud to request to acquire a file 503_1.

In a case that the edge cloud 502 determines that the file 503_1 corresponding to the first resource identifiers respectively corresponding to a plurality of information acquisition requests from the terminal 501_Q, the terminal 501_1, the terminal 501_2, . . . , the terminal 501_q, . . . , the terminal 501_Q does not exist in the resource set of the edge cloud 502 by using an integrated instance, the edge cloud 502 may generate an information acquisition request and send the information acquisition request to the target end 503 to request to acquire the file 503_1.

The target end 503 may store a file 503_1, a file 503_2, . . . , a file 503_t, . . . , a file 503_T. The edge cloud 502 may acquire the file 503_1 from the target end 503 via the information acquisition request to complete a public network download. The terminal 501_1, the terminal 501_2, . . . , the terminal 501_q, . . . , the terminal 501_Q may acquire the file 503_1 from the edge cloud 502 via the information acquisition request to complete a local area network download.

According to embodiments of the present disclosure, the information processing method 200 may further include the following operations.

The second resource download request is generated according to a second resource identifier by using the integrated instance. The second resource download request is sent to the IoT platform by using the integrated instance, such that the IoT platform acquires a second resource corresponding to the second resource identifier. In response to receiving the second resource from the IoT platform, the second resource and the second resource identifier are stored in association by using the integrated instance.

According to embodiments of the present disclosure, the source end may be an IoT platform. The information processing request may include an Over-the-Air (OTA) upgrade request. The parsed information may include a second resource identifier. The second resource identifier may represent an OTA resource identifier.

According to embodiments of the present disclosure, the OTA upgrade request may refer to over-the-air download, i.e., remote wireless upgrade technology. In a case that the source end is an IoT platform and the target end is a terminal, the edge cloud may use a parsing routine to parse the OTA upgrade request to obtain a second resource identifier. The second resource identifier may represent an OTA resource identifier. The OTA resource identifier may include an MD5 value of the OTA resource and address information of the OTA resource.

According to embodiments of the present disclosure, after obtaining the second resource identifier, a second resource download request may be generated according to the second resource identifier. After obtaining the second resource download request, the second resource download request may be sent to the IoT platform by using the integrated instance. After receiving the second resource download request, the IoT platform may determine the second resource identifier in the second resource download request. The IoT platform may acquire the second resource corresponding to the second resource identifier according to the second resource identifier.

According to embodiments of the present disclosure, after obtaining the second resource corresponding to the second resource identifier, the IoT platform may send the second resource to the edge cloud. In response to receiving the second resource from the IoT platform, the edge cloud may store the second resource identifier and the second resource in association by using the integrated instance, so as to save the second resource in edge storage.

According to embodiments of the present disclosure, in a case that the source end is a terminal device, the target end is the IoT platform, and the information processing request is a current OTA report request, the parsed information includes current OTA report information, and the orchestration information is used to control the IoT platform to execute a service operation of generating a next OTA instruction issuance request according to the current OTA report information, where the next OTA instruction issuance request includes a next OTA instruction. In a case that the source end is the IoT platform, the target end is the terminal device, and the information processing request is a current OTA instruction issuance request, the parsed information includes a current OTA instruction, and the orchestration information is used to control the terminal device to execute a service operation corresponding to the current OTA instruction and generate a next OTA report request if the service operation is completed, where the next OTA report request includes next OTA report information.

According to embodiments of the present disclosure, the information processing request may include an OTA report request and an OTA instruction issuance request. The OTA instruction issuance request may refer to an OTA command issued by the cloud. The OTA report request may refer to an OTA command fed back by the terminal device. An uplink parsing script and a downlink parsing script may be predefined, and the OTA process of the terminal device may be defined in the script in the form of Function as a Service (FaaS). FaaS may refer to splitting the business logic of an application into independent small functions, where each small function is responsible for a specific function, and automatic invocation and operation of the function are implemented through event-driven or API gateway. The downlink parsing script is used to perform OTA downlink parsing on the OTA instruction issuance request. For example, the information processing method may be applied to define the OTA process of the terminal device in the form of Function as a Service to realize management and control of screen display.

According to embodiments of the present disclosure, in a case that the source end is a terminal device, the target end is an IoT platform, and the information processing request is a current OTA report request, an uplink parsing script may be used to perform OTA uplink parsing on the OTA report request. A parsing routine may be used to parse the information reported by each terminal device respectively, and map key content in the information reported by each terminal device to a fixed system reserved field to obtain current OTA report information corresponding to each terminal device.

According to embodiments of the present disclosure, on this basis, a logic orchestration routine may be used to perform logic orchestration on the current OTA report information corresponding to each terminal device respectively, so as to obtain orchestration information for controlling the IoT platform to execute the service operation of generating a next OTA instruction issuance request according to the current OTA report information, facilitating the realization of mapping and binding between the uplink data of the terminal device and a device shadow in the IoT platform.

According to embodiments of the present disclosure, a device shadow may refer to a “shadow” device virtually created for each terminal device, which may be used to record and store information such as state, configuration, and metadata of the terminal device, so as to facilitate the application to control and manage the terminal device through a cloud service. The device shadow may include a device state, a shadow state, a version number, and an API interface. The device state may be used to represent the current state of the terminal device. The shadow state may be used to represent the shadow state of the terminal device. The version number may be used to represent the version numbers of the device state and the shadow state. The API interface may be used to perform read-write operations on the device shadow through the cloud service, so as to synchronize with an actual state of the terminal device.

According to embodiments of the present disclosure, in a case that the source end is an IoT platform, the target end is a terminal device, and the information processing request is a current OTA instruction issuance request, a downlink parsing script may be used to perform OTA downlink parsing on the current OTA instruction issuance request. A parsing routine may be used to parse a device command issued by the IoT platform, assemble the key content into a message format recognizable by the terminal device, and map the assembled message to the fixed system reserved field to obtain the current OTA instruction.

According to embodiments of the present disclosure, on this basis, logic orchestration may be performed on the current OTA instruction by using a logic orchestration routine, so as to obtain orchestration information for controlling the terminal device to execute the service operation corresponding to the current OTA instruction, facilitating the realization of command issuance.

According to embodiments of the present disclosure, by pre-writing the uplink parsing script and the downlink parsing script, a complete over-the-air upgrade process may be realized without caring about the difference between the standard protocol of the IoT platform and the protocol implemented by the terminal, as well as the difference between the process of the IoT platform and the process implemented by the terminal.

FIG. 6 schematically shows an example diagram of an information processing process according to an embodiment of the present disclosure.

As shown in FIG. 6, in 600, in a case that the source end is a terminal device 601, the target end is an IoT platform 603, and the information processing request is a current OTA report request, an edge cloud 602 may use an uplink converter 602_1 to convert the current OTA report request, and use a parsing routine 602_2 to parse the current OTA report request to obtain current OTA report information. On this basis, the edge cloud 602 may use a logic orchestration routine 602_3 to perform logic orchestration on the current OTA report information to obtain processing information 602_4.

In a case that the source end is the IoT platform 603, the target end is the terminal device 601, and the information processing request is a current OTA instruction issuance request, the edge cloud 602 may use a downlink converter 602_5 to convert the current OTA instruction issuance request, and use a parsing routine 602_6 to parse the current OTA report request to obtain a current OTA instruction. On this basis, the edge cloud 602 may use a logic orchestration routine 602_7 to perform logic orchestration on the current OTA instruction to obtain processing information 602_8.

According to embodiments of the present disclosure, in a case that the source end is an IoT platform and the target end is a terminal device, the orchestration information includes a control instruction group, and at least one control instruction included in the control instruction group has an association relationship with each other.

According to embodiments of the present disclosure, in a case that the source end is an IoT platform and the target end is a terminal device, the edge cloud may use a JS engine to parse the information processing request to obtain a parsing result. On this basis, the edge cloud may use a logic orchestration routine to perform logic orchestration on the parsing result to obtain a control instruction group, so as to realize conversion from a simple command to a complex command group, thereby supporting orchestration of complex terminal device actions. The control instruction group may include a plurality of control instructions. The edge cloud may use the logic orchestration routine to sequentially issue at least one control instruction in the control instruction group at a predetermined time interval. Each of the plurality of control instructions corresponds to a device action, and the device actions corresponding to the plurality of control instructions may be combined to implement a complex action. For example, the information processing method may be applied to define the control instruction group of the terminal device in the form of Function as a Service to realize management of asset items.

According to embodiments of the present disclosure, the edge cloud may issue a control instruction to a specific terminal device according to the parsing result. The edge cloud may execute the logic of the control instruction group according to the parsing result, and sequentially issue at least one control instruction in the control instruction group to the corresponding terminal device at a predetermined time interval.

According to embodiments of the present disclosure, the at least one control instruction included in the control instruction group has an association relationship with each other, which may include at least one of the following.

The at least one control instruction has a timing relationship with each other. There are control instructions with a dependency relationship among the at least one control instruction.

According to embodiments of the present disclosure, the association relationship may include at least one of: a timing relationship or a dependency relationship. The timing relationship may refer to a temporal relationship between different control instructions in the at least one control instruction, i.e., indicating which control instruction should start or end before another control instruction. The dependency relationship may refer to a logical relationship between different control instructions in the at least one control instruction, i.e., indicating which control instruction requires another control instruction to have started or completed, i.e., requiring a precondition to be met.

According to embodiments of the present disclosure, the information processing method 200 may further include the following operations.

The parsed information is authenticated by using the parsing routine to obtain authentication information.

According to embodiments of the present disclosure, the performing logic orchestration on the parsed information by using the logic orchestration routine to obtain the processing information may include the following operations.

In response to determining that the authentication information corresponding to the parsed information indicates that authentication is passed by using the integrated instance, logic orchestration is performed on the parsed information by using the logic orchestration routine to obtain the processing information.

According to embodiments of the present disclosure, identity authentication of the terminal device may be realized by authenticating the parsed information by using the parsing routine. An authentication script may be predefined. After obtaining the parsed information, the parsing routine may be used to authenticate the parsed information based on the authentication script to obtain authentication information. The specific manner of authenticating the parsed information may be configured according to actual service requirements, which is not limited herein.

For example, field detection processing may be performed on the parsed information according to a target field name to obtain a field detection result. In a case that the field detection result indicates that there is a target field value corresponding to the target field name in the parsed information, authentication information indicating that authentication is passed may be determined, and the terminal device may go online normally. In a case that the field detection result indicates that there is no target field value corresponding to the target field name in the parsed information, authentication information indicating that authentication is not passed may be determined, and service provision for the terminal device is refused.

According to embodiments of the present disclosure, the target field name may be configured according to actual service requirements, which is not limited herein. For example, the target field name may include at least one of: sequence number (i.e. sn), category, or message type (msgType).

According to embodiments of the present disclosure, in a case of determining that the authentication information corresponding to the parsed information indicates that authentication is passed, the parsed information may be delivered to logic orchestration, and the logic orchestration routine may be used to perform logic orchestration on the parsed information to obtain processing information. Logic orchestration may be used to realize arrangement and combination of device actions, such as device registration and going online, device data reporting, command issuance, and OTA upgrade.

According to embodiments of the present disclosure, for downlink parsed data, the edge cloud may directly return the parsed information to the terminal without authentication. For uplink parsed data, in a case of determining that the authentication information corresponding to the parsed information indicates that authentication is passed, the edge cloud may notify the logical device to report shadow data, report events, report command replies and the like according to the parsing result.

According to embodiments of the present disclosure, the parsing the information processing request by using the parsing routine to obtain parsed information may include the following operations.

The information processing request is parsed by using the parsing routine, so as to obtain at least one parsed field. The at least one parsed field is added to a predetermined template by using the parsing routine, so as to obtain the parsed information.

According to embodiments of the present disclosure, the edge cloud may be deployed with a converter. The converter may be used to convert the data format of differentiated terminal devices into a unified data format of the IoT platform. The converter may include an uplink data converter and a downlink data converter. The converter may include a JS engine. The JS engine, when being executed, may parse and execute JavaScript script logic. The JS engine includes a plurality of script execution units, and the plurality of script execution units may work in parallel to improve the overall throughput of the JS engine.

According to embodiments of the present disclosure, among the plurality of terminals using the same communication protocol, different terminals may require different data formats. For the same integrated instance, since data conversion of a plurality of data formats needs to be dealt with, a set of converters may be configured for each data format to perform conversion processing on the terminals communicating in the data format. An integrated instance may be associated with one or more sets of converters, where one set of converters corresponds to conversion between the data format required by the IoT platform and one data format of the terminal. The parsing routine may be used to parse the information processing request to obtain at least one parsed field.

According to embodiments of the present disclosure, the predetermined template may include a predetermined uplink parsing template and a predetermined downlink parsing template. The predetermined uplink parsing template may be used to perform conversion of the data to be uplinked to the IoT platform, i.e., used to convert the information processing request sent from the terminal to the IoT platform into a data format adapted to the IoT platform. The predetermined downlink parsing template may be used to perform conversion of the data to be issued from the IoT platform to the terminal, i.e., used to convert the information processing request sent from the IoT platform to the terminal into a data format adapted to the terminal.

According to embodiments of the present disclosure, after obtaining at least one uplink parsed field and at least one downlink parsed field, the at least one uplink parsed field may be added to the predetermined uplink parsing template by using the parsing routine, so as to obtain uplink parsed information. The at least one downlink parsed field may be added to the predetermined downlink parsing template by using the parsing routine, so as to obtain downlink parsed information.

According to embodiments of the present disclosure, operation S230 may include the following operations.

The orchestration information is sent to the target end according to a communication protocol of the target end corresponding to the target end identifier by using a logical device corresponding to the logical device identifier, where the logical device is deployed in the integrated instance.

According to embodiments of the present disclosure, the processing information may further include a logical device identifier.

According to embodiments of the present disclosure, the logical device identifier may be used to represent different logical devices. The logical device identifier may include at least one of: Serial Number (SN), Universally Unique Identifier (UUID), or Media Access Control Address (MAC) of the terminal.

According to embodiments of the present disclosure, a logical device may refer to a virtual module corresponding to a terminal and connected to the IoT platform. The logical device may establish a one-to-one correspondence with a direct-connected terminal device or a gateway sub-terminal device of the terminal, and a device shadow of the IoT platform. Each logical device may respectively create an MQTT connection, and each MQTT connection may subscribe to data received by the corresponding terminal and issued by the IoT platform to the terminal. The logical device may be deployed in the integrated instance. The integrated instance may be used to manage all logical devices deployed on the integrated instance.

According to embodiments of the present disclosure, in a case that the source end is a terminal and the target end is an IoT platform (i.e., uplink), a direct-connected terminal device or a gateway sub-terminal device may be mapped to a device serial number through a connection address, further mapped to a logical device through the device serial number, and then mapped to a device shadow through the logical device, so as to realize data sending from the terminal device or gateway sub-terminal device to the IoT platform and update the device shadow.

According to embodiments of the present disclosure, in a case that the source end is an IoT platform and the target end is a terminal (i.e., downlink), a logical device may be mapped to a device shadow, further mapped to a device serial number through the logical device, mapped to a connection address through the device serial number, and then mapped to a connection through the connection address, so as to realize issuance of commands from the IoT platform to the terminal device or gateway sub-terminal device through the connection.

According to embodiments of the present disclosure, the parsed information further includes a source end identifier, and the logical device identifier is determined by using the integrated instance according to the source end identifier.

According to embodiments of the present disclosure, the edge cloud may maintain a mapping relationship between connections and logical devices. For example, in a case that the source end is a terminal and the target end is an IoT platform (i.e., a terminal device or a gateway reports data), a logical device may be found through a connection, i.e., by using the integrated instance, a logical device identifier is determined according to a source end identifier, and final data reporting is completed by the logical device corresponding to the logical device identifier.

Alternatively, in a case that the source end is an IoT platform and the target end is a terminal (i.e., the IoT platform issues a command), a connection may be found through a logical device, i.e., by using the integrated instance, a logical device identifier is determined according to a source end identifier, and the command is issued to the terminal device or gateway through the connection.

According to embodiments of the present disclosure, operation S230 may further include the following operations.

By using the integrated instance, the logical device is monitored to obtain first monitoring information. By using the integrated instance, the logical device is repaired in a case of determining that the logical device has a fault according to the first monitoring information.

According to embodiments of the present disclosure, the first monitoring information may be used to represent the operating state of the logical device. The logical device may be monitored by using the integrated instance, so as to obtain first monitoring information corresponding to the logical device. On this basis, a faulty logical device may be determined according to the first monitoring information corresponding to the logical device. The faulty logical device may be repaired. The repair may include at least one of: stopping, restarting, or replacing.

According to embodiments of the present disclosure, the specific manner of monitoring the logical device may be configured according to actual service requirements, which is not limited herein. For example, it is possible to send a heartbeat packet to the logical device, and receive a data packet returned by the logical device. The operating state of the logical device may be determined according to the data packet returned by the logical device, and the logical device whose operating state indicates a fault may be restarted. Alternatively, a monitoring program may be developed, and the monitoring program may be used to monitor the operating state of the logical device and determine whether the logical device is online or not, and restart the offline logical device with an operating state indicating a fault.

According to embodiments of the present disclosure, the operating state may include at least one of: an operating state or a service state. The operating state may refer to the operating status of the logical device, i.e., whether the logical device operates normally. The service state may indicates whether the forwarding of interactive data packets between the IoT platform and the terminal during the logical device's provision of information processing services is normal.

According to embodiments of the present disclosure, monitoring the logical device may include monitoring the operating state of the logical device. Alternatively, monitoring the logical device may include monitoring the service state of the logical device. Alternatively, monitoring the logical device may include monitoring both the operating state and the service state of the logical device.

According to embodiments of the present disclosure, the first monitoring information may include at least one of: a heartbeat data packet and an operating log during operation. For example, in a case that the first monitoring information includes the heartbeat data packet, the instance object corresponding to the logical device may be used to periodically capture the heartbeat data packet of the logical device during operation, and determine the operating state of the logical device according to the captured heartbeat data packet.

According to embodiments of the present disclosure, alternatively, in a case that the first monitoring information includes an operating log during operation, the instance object corresponding to the logical device may be used to obtain the operating log of the logical device during operation by monitoring a specified channel, and determine the operating state and the service state of the logical device according to the obtained operating log during operation.

According to embodiments of the present disclosure, a fault in the operating state of the logical device may be detected by checking whether the process is alive and whether the service is available. A fault in the service state of the logical device may be detected by detecting a fault code in the operating log. If a faulty logical device is identified, the instance object may feed back the operating state of the faulty logical device to an access component, so as to determine the specific manner of repairing the faulty logical device according to the information fed back by the access component for the fault state.

The above are only exemplary embodiments, but the present disclosure is not limited thereto, and may further include other information processing methods known in the art, as long as the efficiency of information processing may be improved, and the communication efficiency between the source end and the target end may be improved.

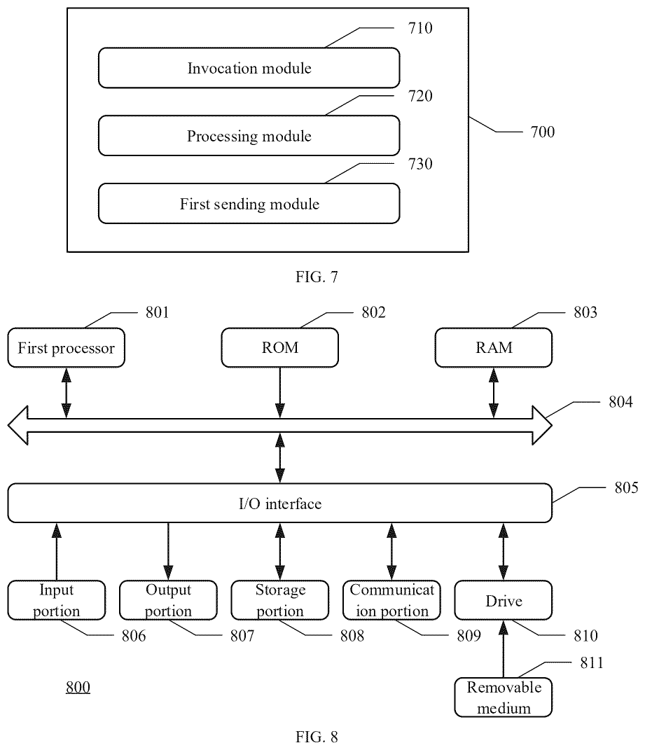

FIG. 7 schematically shows a block diagram of an information processing apparatus according to an embodiment of the present disclosure.

As shown in FIG. 7, an information processing apparatus 700 may include an invocation module 710, a processing module 720, and a first sending module 730.

The invocation module 710 is used to, in response to receiving an information processing request from a source end, invoke an integrated instance corresponding to the information processing request, where the integrated instance supports a corresponding communication protocol, and the integrated instance is deployed on an edge cloud.

The processing module 720 is used to process the information processing request by using the integrated instance to obtain processing information, where the processing information includes a target end identifier and orchestration information.

The first sending module 730 is used to send the orchestration information to a target end corresponding to the target end identifier by using the integrated instance, such that the target end executes a service operation corresponding to the orchestration information.

According to embodiments of the present disclosure, the integrated instance includes a parsing routine and a logic orchestration routine.

According to embodiments of the present disclosure, the processing module 720 may include a parsing unit and a logic orchestration unit.

The parsing unit is used to parse the information processing request by using the parsing routine to obtain parsed information.

The logic orchestration unit is used to perform logic orchestration on the parsed information by using the logic orchestration routine to obtain processing information.

According to embodiments of the present disclosure, the source end is a terminal device, the information processing request is an information acquisition request, and the parsed information includes a first resource identifier.

According to embodiments of the present disclosure, the information processing apparatus 700 may further include a first generation module, a second sending module, and a third sending module.

The first generation module is used to, in response to determining that a first resource corresponding to a first resource identifier does not exist in a resource set by using an integrated instance, generate a first resource download request according to the first resource identifier.

The second sending module is used to send the first resource download request to the IoT platform by using the integrated instance, such that the IoT platform acquires the first resource corresponding to the first resource identifier.

The third sending module is used to, in response to receiving the first resource from the IoT platform by using the integrated instance, send the first resource to the terminal device.

According to embodiments of the present disclosure, the information processing apparatus 700 may further include a first association storage module.

The first association storage module is used to store the first resource and the first resource identifier in association in a resource set by using the integrated instance.

According to embodiments of the present disclosure, a plurality of information acquisition requests are provided, and at least one terminal device is provided.

According to embodiments of the present disclosure, the first generation module may include a generation unit.

The generation unit is used to, in response to determining that first resources corresponding to first resource identifiers respectively corresponding to a plurality of information acquisition requests do not exist in the resource set by using the integrated instance, and in a case of determining that the plurality of first resource identifiers are consistent, generate the first resource download request according to the first resource identifier.

According to embodiments of the present disclosure, the source end is an IoT platform, the information processing request includes an Over-the-Air (OTA) upgrade request, the parsed information includes a second resource identifier, and the second resource identifier represents an OTA resource identifier.

According to embodiments of the present disclosure, the information processing apparatus 700 may further include a second generation module, a fourth sending module, and a second association storage module.

The second generation module is used to generate a second resource download request according to the second resource identifier by using the integrated instance.

The fourth sending module is used to send the second resource download request to the IoT platform by using the integrated instance, such that the IoT platform acquires a second resource corresponding to the second resource identifier.

The second association storage module is used to, in response to receiving the second resource from the IoT platform by using the integrated instance, store the second resource and the second resource identifier in association.

According to embodiments of the present disclosure, in a case that the source end is a terminal device, the target end is an IoT platform, and the information processing request is a current OTA report request, the parsed information includes current OTA report information, and the orchestration information is used to control the IoT platform to execute a service operation of generating a next OTA instruction issuance request according to the current OTA report information, where the next OTA instruction issuance request includes a next OTA instruction.

According to embodiments of the present disclosure, in a case that the source end is an IoT platform, the target end is a terminal device, and the information processing request is a current OTA instruction issuance request, the parsed information includes a current OTA instruction, and the orchestration information is used to control the terminal device to execute a service operation corresponding to the current OTA instruction, and generate a next OTA report request in a case that the service operation is completed, where the next OTA report request includes next OTA report information.

According to embodiments of the present disclosure, in a case that the source end is an IoT platform and the target end is a terminal device, the orchestration information includes a control instruction group, and at least one control instruction included in the control instruction group has an association relationship with each other.

According to embodiments of the present disclosure, the at least one control instruction included in the control instruction group has an association relationship with each other, and the association relationship includes at least one of: the at least one control instruction has a timing relationship with each other, or the at least one control instruction includes control instructions with a dependency relationship.

According to embodiments of the present disclosure, the information processing apparatus 700 may further include an authentication module.

The authentication module is used to authenticate the parsed information by using the parsing routine to obtain authentication information.

According to embodiments of the present disclosure, the logic orchestration unit may include a logic orchestration subunit.

The logic orchestration subunit is used to, in response to determining that the authentication information corresponding to the parsed information indicates that authentication is passed by using the integrated instance, perform logic orchestration on the parsed information by using the logic orchestration routine to obtain the processing information.

According to embodiments of the present disclosure, the parsing unit may include a parsing subunit and an adding subunit.

The parsing subunit is used to parse the information processing request by using the parsing routine to obtain at least one parsed field.

The adding subunit is used to add the at least one parsed field to a predetermined template by using the parsing routine to obtain the parsed information.

According to embodiments of the present disclosure, the processing information further includes a logical device identifier.

According to embodiments of the present disclosure, the first sending module 730 may include a sending unit.

The sending unit is used to send the orchestration information to the target end according to a communication protocol of the target end corresponding to the target end identifier by using a logical device corresponding to the logical device identifier, where the logical device is deployed in the integrated instance.

According to embodiments of the present disclosure, the parsed information further includes a source end identifier, and the logical device identifier is determined according to the source end identifier by using the integrated instance.

According to embodiments of the present disclosure, the first sending module 730 may further include a first monitoring unit and a first repair unit.

The first monitoring unit is used to monitor the logical device by using the integrated instance to obtain first monitoring information.

The first repair unit is used to repair the logical device in a case of determining that the logical device has a fault according to the first monitoring information by using the integrated instance.

According to embodiments of the present disclosure, the invocation module 710 may include a first determining unit and an invocation unit.

The first determining unit is used to determine an integrated instance corresponding to a listening port from a plurality of integrated instances in response to detecting an information processing request from a source end at the listening port,.

The invocation unit is used to invoke the integrated instance corresponding to the listening port.

According to embodiments of the present disclosure, the invocation module 710 may include a storage unit.

The storage unit is used to store the information processing request detected at the listening port into a message queue, so as to acquire the information processing request from the message queue.

According to embodiments of the present disclosure, the invocation module 710 may further include a second monitoring unit and a second repair unit.

The second monitoring unit is used to monitor listening ports respectively corresponding to the plurality of integrated instances to obtain second monitoring information respectively corresponding to the plurality of integrated instances.

The second repair unit is used to repair a faulty integrated instance in response to the faulty integrated instance being identified according to the second monitoring information respectively corresponding to the plurality of integrated instances.

According to embodiments of the present disclosure, the invocation module 710 may further include a second determining unit.

The second determining unit is used to determine a target integrated instance corresponding to the faulty integrated instance from at least one alternative integrated instance, so as to replace the faulty integrated instance with the target integrated instance.

According to embodiments of the present disclosure, the information processing apparatus 700 may further include an acquisition module and a creation module.

The acquisition module is used to, in response to detecting a creation instruction for an integrated instance, acquire instance configuration information corresponding to the creation instruction.

The creation module is used to create an integrated instance according to the instance configuration information.

Any number of modules, sub-modules, units, sub-units, or at least part of the function of any number thereof according to embodiments of the present disclosure may be implemented in one module. Any one or more of the modules, sub-modules, units, and sub-units according to embodiments of the present disclosure may be divided into a plurality of modules for implementation. Any one or more of the modules, sub-modules, units, sub-units according to embodiments of the present disclosure may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware, and firmware. Alternatively, one or more of the modules, sub-modules, units, and sub-units according to embodiments of the present disclosure may be implemented at least partially as a computer program module, which when executed, may perform a corresponding function.

For example, any number of the invocation module 710, the processing module 720, and the first sending module 730 may be combined into one module/unit/sub-unit to be implemented, or any one of the modules/units/sub-units may be divided into a plurality of modules/units/sub-units. Alternatively, at least part of the function of one or more of these modules/units/sub-units may be combined with at least part of the function of other modules/units/sub-units and implemented in one module/unit/sub-unit. According to embodiments of the present disclosure, at least one of the invocation module 710, the processing module 720, and the first sending module 730 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware and firmware. Alternatively, at least one of the invocation module 710, the processing module 720, and the first sending module 730 may be implemented at least partially as a computer program module, which when executed, may perform a corresponding function.

It should be noted that the information processing apparatus portion in embodiments of the present disclosure corresponds to the information processing method portion in embodiments of the present disclosure, and the description of the information processing apparatus portion specifically refers to the information processing method portion, and will not described in detail herein.

FIG. 8 schematically shows a block diagram of an electronic device suitable for implementing an information processing method according to an embodiment of the present disclosure. The electronic device shown in FIG. 8 is merely an example and should not impose any limitation on the function and scope of use of embodiments of the present disclosure.

As shown in FIG. 8, the electronic device 800 according to embodiments of the present disclosure includes a processor 801 that may perform various appropriate actions and processes according to programs stored in a read-only memory (ROM) 802 or programs loaded from a storage portion 808 into a random access memory (RAM) 803. The processor 801 may include, for example, a general-purpose microprocessor (e.g., a CPU), an instruction set processor and/or a related chipset and/or a special-purpose microprocessor (e.g., an application-specific integrated circuit (ASIC)), etc. The processor 801 may also include an on-board memory for caching purposes. The processor 801 may include a single processing unit or a plurality of processing units for performing different actions of a method flow according to embodiments of the present disclosure.

In the RAM 803, various programs and data required for the operation of the electronic device 800 are stored. The processor 801, the ROM 802 and the RAM 803 are connected to each other through a bus 804. The processor 801 performs various operations of the method flow according to embodiments of the present disclosure by executing the programs in the ROM 802 and/or the RAM 803. It should be noted that the programs may also be stored in one or more memories other than the ROM 802 and the RAM 803. The processor 801 may also perform various operations of the method flow according to embodiments of the present disclosure by executing the programs stored in the one or more memories.

According to embodiments of the present disclosure, the electronic device 800 may also include an input/output (I/O) interface 805, and the input/output (I/O) interface 805 is also connected to the bus 804. The electronic device 800 may also include one or more of the following components connected to the input/output (I/O) interface 805: an input portion 806 including a keyboard, a mouse, etc.; an output portion 807 including a cathode ray tube (CRT), a liquid crystal display (LCD), etc., and a speaker, etc.; a storage portion 808 including a hard disk, etc.; and a communication portion 809 including a network interface card such as a LAN card, a modem, etc. The communication portion 809 performs communication processing via a network such as the Internet. A drive 810 is also connected to the input/output (I/O) interface 805 as needed. A removable medium 811, such as a magnetic disk, an optical disk, a magneto-optical disk, a semiconductor memory, etc., is mounted on the drive 810 as needed so that a computer program read therefrom is installed into the storage portion 808 as needed.

According to embodiments of the present disclosure, the method flow according to embodiments of the present disclosure may be implemented as a computer software program. For example, an embodiment of the present disclosure includes a computer program product including a computer program carried on a computer-readable medium, and the computer program contains program code for performing the method illustrated in the flowchart. In such an embodiment, the computer program may be downloaded from the network via the communication portion 809 and installed, and/or installed from the removable medium 811. The computer program, when executed by the processor 801, performs the functions described above defined in the system of embodiments of the present disclosure. According to embodiments of the present disclosure, the system, device, apparatus, module, unit, etc. described above may be implemented by the computer program module.

The present disclosure further provides a computer-readable medium. The computer-readable medium may be included in the device/apparatus/system described in the above-mentioned embodiments, and may also exist alone without being assembled into the device/apparatus/system. The computer-readable medium described above carries one or more programs, and when the one or more programs are executed, the method according to embodiments of the present disclosure may be implemented.

According to embodiments of the present disclosure, the computer-readable medium may be a nonvolatile computer-readable storage medium. The computer-readable storage medium may include, for example, but are not limited to, a portable computer disk, a hard disk, a random access memory (RAM), a read only memory (ROM), an erasable programmable read only memory (EPROM or flash memory), a portable compact disk read only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device.

For example, according to embodiments of the present disclosure, the computer-readable medium may include one or more memories other than the ROM 802 and/or the RAM 803 and/or the ROM 802 and the RAM 803 described above.

Embodiments of the present disclosure further include a computer program product which includes a computer program. The computer program includes program code for implementing the method provided by embodiments of the present disclosure. When the computer program product runs on the electronic device, the program code is used to enable the electronic device to implement the information processing method provided by embodiments of the present disclosure.

When the computer program is executed by the processor 801, the above-mentioned functions defined in the system/device of embodiments of the present disclosure are performed. According to embodiments of the present disclosure, the system, device, module, unit, etc. described above may be realized by the computer program module.

In an embodiment, the computer program may rely on a tangible storage media such as an optical storage device and a magnetic storage device. In another embodiment, the computer program may also be transmitted and distributed in a form of signals on a network media, downloaded through the communication section 809 and installed, and/or installed from the removable medium 811. The program code contained in the computer program may be transmitted by any appropriate network medium, including but not limited to: wireless, wired, etc., or any suitable combination of the above.

According to embodiments of the present disclosure, program codes for implementing the computer programs provided by embodiments of the present disclosure may be written in one programming language or any combination of more programming languages. Specifically, the computing programs may be implemented using advanced procedure-oriented and/or object-oriented programming languages, and/or assembler/machine languages. Programming languages include but are not limited to Java, C++, Python, “C” or similar programming languages. The program codes may be executed entirely on a user computing device, partially on a user device and partially on a remote computing device, or entirely on a remote computing device or server. In situations involving the remote computing device, the remote computing device may be connected to the user computing device through any kind of network, including a local area network (LAN) or a wide area network (WAN), or the user computing device may be connected to an external computing device (for example, using an Internet service provider to connect via the Internet).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of code, which contains one or more executable instructions for implementing the specified logical function. It should also be noted that, in some alternative implementations, the functions noted in the blocks may occur out of the order noted in the drawings. For example, two blocks shown in succession may, in fact, be executed substantially concurrently, or the two blocks may sometimes be executed in a reverse order, depending upon the functionality involved. It should also be noted that each block of the block diagrams or flowcharts, and combinations of the blocks in the block diagrams or flowcharts, may be implemented by using a special purpose hardware-based system that performs the specified functions or operations, or may be implemented using a combination of a special purpose hardware and computer instructions. Those skilled in the art will appreciate that features recited in the various embodiments of the present disclosure and/or the claims may be combined and/or incorporated in a variety of ways, even if such combinations or incorporations are not clearly recited in the present disclosure. In particular, the features recited in the various embodiments of the present disclosure and/or the claims may be combined and/or incorporated in a variety of ways without departing from the spirit and teachings of the present disclosure, and all such combinations and/or incorporations fall within the scope of the present disclosure.

Embodiments of the present disclosure have been described above. However, these embodiments are for illustrative purposes only, and are not intended to limit the scope of the present disclosure. Although the various embodiments are described above separately, this does not mean that the measures in the various embodiments may not be advantageously used in combination. The scope of the present disclosure is defined by the appended claims and their equivalents. Without departing from the scope of the present disclosure, those skilled in the art may make various substitutions and modifications, and these substitutions and modifications should all fall within the scope of the present disclosure.

1. An information processing method, comprising:
invoking, in response to receiving an information processing request from a source end, an integrated instance corresponding to the information processing request, wherein the integrated instance supports a corresponding communication protocol, and the integrated instance is deployed on an edge cloud;
processing the information processing request by using the integrated instance to obtain processing information, wherein the processing information comprises a target end identifier and orchestration information; and
sending the orchestration information to a target end corresponding to the target end identifier by using the integrated instance, such that the target end executes a service operation corresponding to the orchestration information.

2. The method according to claim 1, wherein the integrated instance comprises a parsing routine and a logic orchestration routine; and
wherein the processing the information processing request by using the integrated instance to obtain processing information comprises:
parsing the information processing request by using the parsing routine to obtain parsed information; and
performing logic orchestration on the parsed information by using the logic orchestration routine to obtain the processing information.

3. The method according to claim 2, wherein the source end is a terminal device, the information processing request is an information acquisition request, and the parsed information comprises a first resource identifier; and
the method further comprises:
generating, in response to determining that a first resource corresponding to the first resource identifier does not exist in a resource set, a first resource download request according to the first resource identifier by using the integrated instance;
sending the first resource download request to an IoT platform by using the integrated instance, such that the IoT platform acquires the first resource corresponding to the first resource identifier; and
sending, in response to receiving the first resource of the IoT platform, the first resource to the terminal device by using the integrated instance.

4. The method according to claim 3, further comprising:
storing the first resource and the first resource identifier in association in the resource set by using the integrated instance.

5. The method according to claim 3, wherein the information processing request comprises a plurality of information acquisition requests, and the source end comprises at least one terminal device; and
wherein the generating, in response to determining that a first resource corresponding to the first resource identifier does not exist in a resource set, a first resource download request according to the first resource identifier by using the integrated instance comprises:
in response to determining that first resources corresponding to first resource identifiers respectively corresponding to the plurality of information acquisition requests do not exist in the resource set, and that the plurality of first resource identifiers are consistent, generating the first resource download request according to the first resource identifier by using the integrated instance.

6. The method according to claim 2, wherein the source end is an IoT platform, the information processing request comprises an Over-the-Air (OTA) upgrade request, the parsed information comprises a second resource identifier, and the second resource identifier represents an OTA resource identifier; and
the method further comprises:
generating a second resource download request according to the second resource identifier by using the integrated instance;
sending the second resource download request to the IoT platform by using the integrated instance, such that the IoT platform acquires a second resource corresponding to the second resource identifier; and
storing, in response to receiving the second resource of the IoT platform, the second resource and the second resource identifier in association by using the integrated instance.

7. The method according to claim 6, wherein in a case that the source end is a terminal device, the target end is the IoT platform, and the information processing request is a current OTA report request, the parsed information comprises current OTA report information, and the orchestration information is configured to control the IoT platform to execute a service operation of generating a next OTA instruction issuance request according to the current OTA report information, wherein the next OTA instruction issuance request comprises a next OTA instruction; and
in a case that the source end is the IoT platform, the target end is the terminal device, and the information processing request is a current OTA instruction issuance request, the parsed information comprises a current OTA instruction, and the orchestration information is configured to control the terminal device to execute a service operation corresponding to the current OTA instruction, and generate a next OTA report request in a case that the service operation is completed, wherein the next OTA report request comprises next OTA report information.

8. The method according claim 1, wherein in a case that the source end is the IoT platform and the target end is the terminal device, the orchestration information comprises a control instruction group, and at least one control instruction comprised in the control instruction group has an association relationship with each other.

9. The method according to claim 8, wherein the association relationship between the at least one control instruction included in the control instruction group comprises at least one of:
the at least one control instruction has a timing relationship with each other; or
the at least one control instruction comprises control instructions with a dependency relationship.

10. The method according to claim 2, further comprising:
authenticating the parsed information by using the parsing routine to obtain authentication information,
wherein the performing logic orchestration on the parsed information by using the logic orchestration routine to obtain the processing information comprises:
performing, by using the logic orchestration routine, logic orchestration on the parsed information in response to determining that the authentication information corresponding to the parsed information indicates that authentication is passed, so as to obtain the processing information.

11. The method according to claim 2, wherein the parsing the information processing request by using the parsing routine to obtain parsed information comprises:
parsing the information processing request by using the parsing routine to obtain at least one parsed field; and
adding the at least one parsed field to a predetermined template by using the parsing routine to obtain the parsed information.

12. The method according to claim 1, wherein the processing information further comprises a logical device identifier; and
wherein the sending the orchestration information to a target end corresponding to the target end identifier by using the integrated instance comprises:
sending the orchestration information to the target end according to a communication protocol of the target end corresponding to the target end identifier by using a logical device corresponding to the logical device identifier, wherein the logical device is deployed in the integrated instance.

13. The method according to claim 12, wherein the parsed information further comprises a source end identifier, and the logical device identifier is determined according to the source end identifier by using the integrated instance.

14. The method according to claim 12, further comprising:
monitoring the logical device by using the integrated instance to obtain first monitoring information; and
repairing, by using the integrated instance, the logical device in a case of determining that the logical device has a fault according to the first monitoring information.

15. The method according to claim 1, wherein the invoking, in response to receiving an information processing request from a source end, an integrated instance corresponding to the information processing request comprises:
determining, in response to detecting the information processing request from the source end at a listening port, an integrated instance corresponding to the listening port from a plurality of integrated instances; and
invoking the integrated instance corresponding to the listening port.

16. The method according to claim 15, further comprising:
storing the information processing request detected at the listening port in a message queue, so as to acquire the information processing request from the message queue.

17. The method according to claim 15, further comprising:
monitoring listening ports respectively corresponding to the plurality of integrated instances to obtain second monitoring information respectively corresponding to the plurality of integrated instances; and
repairing a faulty integrated instance, in response to the faulty integrated instance being identified according to the second monitoring information respectively corresponding to the plurality of integrated instances;
wherein the method further comprises: in response to the faulty integrated instance being identified according to the second monitoring information respectively corresponding to the plurality of integrated instances, determining a target integrated instance corresponding to the faulty integrated instance from at least one alternative integrated instance, so as to replace the faulty integrated instance with the target integrated instance; and
wherein the method, further comprises: acquiring, in response to detecting a creation instruction for the integrated instance, instance configuration information corresponding to the creation instruction;
and creating the integrated instance according to the instance configuration information.

18-19. (canceled)

20. An information processing system, comprising:
a source end configured to send an information processing request to an edge cloud;
the edge cloud configured to:
invoke, in response to receiving the information processing request, an integrated instance corresponding to the information processing request, wherein the integrated instance supports a corresponding communication protocol;
process the information processing request by using the integrated instance to obtain processing information, wherein the processing information comprises a target end identifier and orchestration information; and
send the orchestration information to a target end corresponding to the target end identifier by using the integrated instance; and
the target end configured to execute a service operation corresponding to the orchestration information.

21. An electronic device, comprising:
one or more processors;
a memory for storing one or more programs,
wherein the one or more programs, when executed by the one or more processors, are configured to cause the one or more processors to implement the method according to claim 1.

22. A computer-readable storage medium having executable instructions therein, wherein the instructions, when executed by a processor, are configured to cause the processor to implement the method according to claim 1.

23. (canceled)
